(19) United States
(12) Patent Application Publication
(10) Pub. No.: US 2010/0306028 A1
(43) Pub. Date: Dec. 2, 2010

(54) METHODS AND APPARATUS TO MODEL WITH GHOST GROUPS

(76) Inventor: John G. Wagner, Cincinnati, OH (US)

Correspondence Address: Hanley, Flight & Zimmerman, LLC, 150 S. Wacker Dr. Suite 2100, Chicago, IL, 60606, US

(21) Appl. No.: 12/476,806

(22) Filed: Jun. 2, 2009

(51) Int. Cl. G06Q 10/00; G06N 5/02

(52) U.S. Cl. 705/10; 706/52

(57) ABSTRACT

Example methods and apparatus to model with ghost respondents are disclosed. A disclosed example method includes estimating discrete choice utility values for a plurality of respondents based on a plurality of market-available products, and dividing the plurality of respondents into groups based on an ownership status of the plurality of market-available products. The example method also includes identifying a test starter product from the plurality of market-available products based on test criteria indicative of a degree of similarity with the new product, generating a ghost group associated with the new product, and assigning utility values of the test starter product to the new product in the ghost group. Additionally, the example method includes tailoring the utility values assigned to the new product with a ghost group utility adjustment rule, and generating a ghost group model to represent consumers of the new product.

### FIELD OF THE DISCLOSURE

This disclosure relates generally to product market research and, more particularly, to methods and apparatus to model with ghost groups.

### BACKGROUND

Market researchers face several challenges to determine product viability in a market and/or determining future product viability related to products that have not yet been introduced into the market. These are significant expenses associated with new product marketing, promotional development and/or advertising costs.

Holder products typically associated with one or more refill products that may be purchased by a consumer when one or more components of the holder product wears-out and/or is consumed. In some circumstances, new refill products may be considered by the market researchers for introduction to the marketplace. In other circumstances, competitive refill products may be designed for use to work with the holder product(s).

### BRIEF DESCRIPTION OF THE DRAWINGS

FIG. 1 is a schematic illustration of an example ghost group modeling system constructed in accordance with the teachings of this disclosure.

FIG. 2 is a schematic illustration of the example starter product manager shown in FIG. 1.

FIGS. 3-6, 8 and 9 are flowcharts representative of example machine readable instructions that may be executed by, for example, the example starter product manager shown in FIGS. 1 and 2.

FIGS. 7A and 7B are tables of example adjustment rules to be used with the example starter product manager shown in FIGS. 1 and 2.

FIG. 10 is a schematic illustration of an example processor platform that may execute the instructions of FIGS. 3-6, 8 and 9 to implement any or all of the example methods and apparatus described herein.

### DETAILED DESCRIPTION

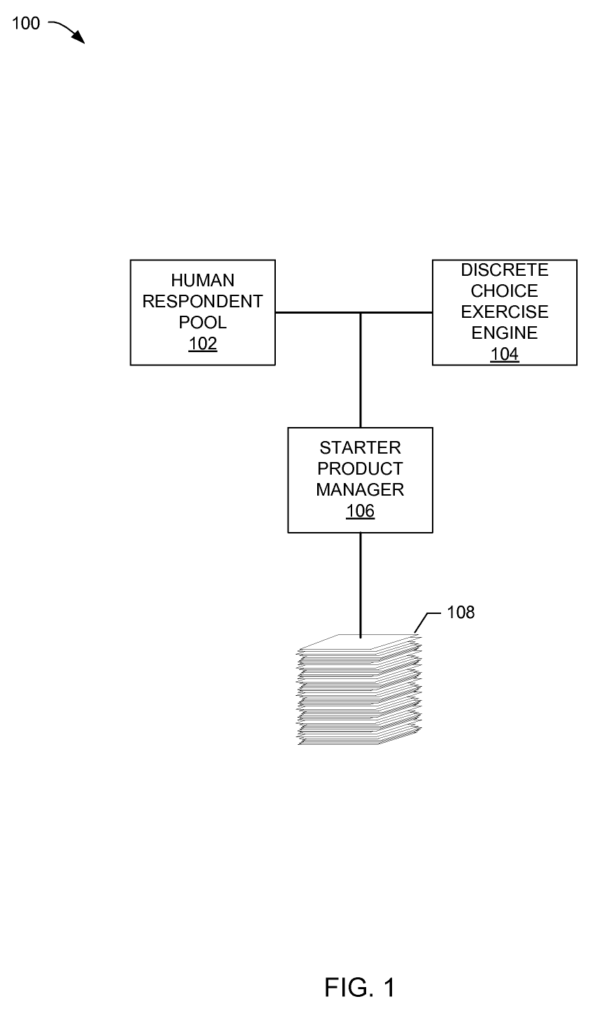

In the interest of brevity and clarity, throughout the following disclosure, references will be made to the example ghost group simulation system 100 of FIG. 1. However, the methods and apparatus described herein to model with ghost groups are applicable to other types of systems constructed using other communication technologies, topologies, and/or elements.

Market researchers, product promoters, marketing employees, agents, and/or other people and/or organizations chartered with the responsibility of product management (hereinafter collectively referred to as “sales forecasters”) typically attempt to justify informal and/or influential marketing decisions using one or more techniques to predict sales of a new product of interest. Accurate forecasting models are useful to facilitate these decisions. In some circumstances, a new product may be evaluated by one or more research panelists/respondents, which are generally selected based upon techniques having a statistically significant confidence level that such respondents accurately reflect a given demographic of interest. Techniques to allow respondents to evaluate a product, which allows the sales forecasters to collect valuable choice data, include focus groups and/or purchasing simulations that allow the respondents to view new product concepts (e.g., providing images of new products on a monitor, asking respondents whether they would purchase the new products, discrete choice exercises, etc.). The methods and apparatus described herein include, in part, one or more modeling techniques to facilitate sales forecasting and allow sales forecasters to execute informed marketing decisions. The one or more modeling techniques described herein may operate with one or more modeling techniques, consumer behavior modeling, and/or choice modeling.

Some new products that have not yet been released and/or introduced to the market include a holder product and one or more corresponding refill products. Generally speaking, a starter product includes both a holder product and a corresponding refill component that may be purchased (e.g., sold separately when a prior refill component wears-out, is consumed, etc.). Example starter products include, but are not limited to, a shave kit (e.g., the shave handle is the holder product and one or more razor cartridges are the refill product), an ink-jet printer (e.g., the printer is the holder product and one or more inkjet cartridges are the refill products), and/or cleaning products (e.g., a mop system is the holder and one or more dry/wet cloth sweep inserts are the refill products). Unlike holder products, determining how likely a respondent is to purchase a corresponding refill product is difficult when neither the holder nor the refill have been in the market. Merely placing a picture of the refill product of interest on a screen for a respondent panelist to consider does not allow the sales forecasters to develop a confident assessment of whether future consumers are likely to purchase that refill product because, in part, refill products are typically tied closely with an associated holder product. In other words, when considering consumer behavior in view of a refill product that does not yet exist in the marketplace and has no corresponding holder product, behavioral predictions are difficult.

Some example methods and apparatus described herein include model development to calculate choice shares in view of given market scenario conditions. In other words, the methods and apparatus described herein reveal purchasing behavior of consumers in the market for starter products (i.e., products having a holder product and a corresponding refill product), but may also be used when modeling other products, such as disposable products. Products have one or more associated consumer preferences (sometimes referred to herein as “utilities”), in which the product utility values may differ for a holder product, a corresponding refill product, and/or a starter product (e.g., a holder product and its corresponding refill product combination). Such utilities may be the result of one or more attributes of the holder, refill and/or starter products. Products may include one or more utility types that specify attributes of the product of interest. Purchasing behavior of consumers depends on, in part, which holders (if any) are possessed by the consumer. Based on estimated utilities, one or more choice probabilities may be calculated to develop one or more discrete choice models that enable the sales forecaster to calculate choice shares, thereby revealing consumer behavior in starter product categories.

Example methods and apparatus to model with ghost groups are disclosed. A disclosed example method includes estimating discrete choice utility values for a plurality of respondents based on a plurality of market-available products, and dividing the plurality of respondents into groups based on an ownership status of the plurality of market-available products. The example method also includes identifying a test starter product from the plurality of market-available products based on test criteria indicative of a degree of similarity with the new product, generating a ghost group associated with the new product, and assigning utility values of the test starter product to the new product in the ghost group. Additionally, the example method includes tailoring the utility values assigned to the new product with a ghost group utility adjustment rule, and generating a ghost group model to represent consumers of the new product.

A disclosed example apparatus includes a utility estimator to estimate discrete choice utility values for a plurality of market-available products, and a product matcher to identify a match between the new product and a test starter product from the plurality of market-available products, the product matcher identifying a degree of similarity between the new product and the test starter product. The example apparatus also includes a ghost group rule manager to generate tailored utility values for the new product based on the test starter product, and a choice share manager to combine the tailored utility values with the discrete choice utility values to create a ghost group model.

FIG. 1 is a schematic illustration of an example ghost group simulation system 100, which monitors a human respondent pool 102. The example human respondent pool 102 may include any number of panelist groupings/sets related to any number of demographic(s) of interest and/or to any number of geographies of interest. Such panelists and/or sets of panelists are human participants to one or more virtual shopping trips that, in part, provide data to allow utility values to be calculated for one or more products. Such panelists may operate as respondents and be selected based on a statistical grouping to allow projection to a larger universe of similar consumers and/or a larger universe of households. Generally speaking, a respondent is a human being that responds to questions and surveys in, for instance, a choice exercise. The example ghost group simulation system 100 includes a discrete choice exercise engine 104 communicatively connected to a starter product manager 106. Generally speaking, the example discrete choice engine 104 obtains choice data from the human respondents of the example respondent pool 102. The example starter product manager 106, in part, estimates corresponding utility values for one or more products of interest based on choice data obtained from the human respondents. As described in further detail below, the example starter product manager 106 also generates ghost groups to represent consumer behavior associated with those consumers that purchase a new product not yet available in the marketplace. Additionally, the example starter product manager 106 employs one or more ghost group adjustment rules to estimate corresponding ghost utility values to be used with the ghost groups when modeling purchase behavior(s).

Generally speaking, ghost groups are generated in a manner to model behavior of individuals that own and/or possess a holder product that does not yet exist in the marketplace, but may exhibit purchasing tendencies of similar products that currently exist in the marketplace. One or more weights may be assigned to the ghost group utility values to simulate purchasing behavior of consumers in a future state when the marketplace includes such holders that are not currently available. Utilities generally describe a relationship between one or more consumers and a product and/or one or more aspects/attributes of a product. Utilities may relate to attributes of product branding, product flavor, product sizing, product price-point, etc. Upon completion of performing one or more virtual shopping trips (e.g., a discrete choice exercise), estimating utilities for the products of interest (e.g., existing marketplace products and new products) to be used with the human respondents, generating the ghost group(s), one or more scenario parameters may be employed to calculate a probability model, thereby allowing the example starter product manager 106 to provide choice share output data 108. Choice share output data 108 may include, but is not limited to reports, charts and/or graphs.

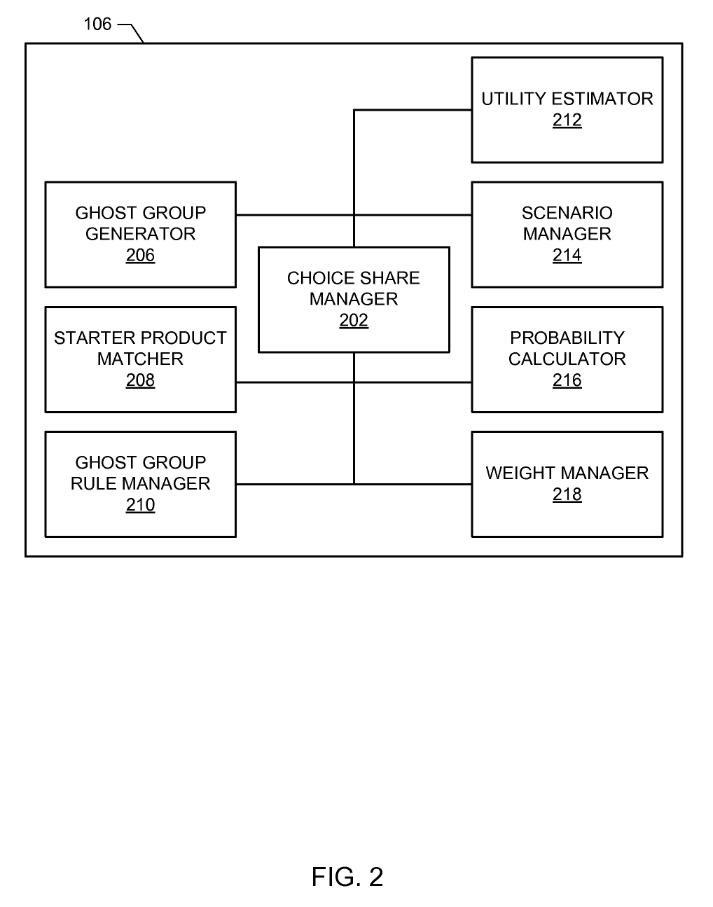

FIG. 2 is a detailed schematic illustration of the example starter product manager 106 of FIG. 1. The example starter product manager 106 includes a choice share manager 202, and a ghost group generator 206. The example starter product manager 106 also includes a starter product matcher 208, a ghost group rule manager 210, a utility estimator 212, a scenario manager 214, a probability calculator 216, and a weight manager 218.

In operation, the example choice share manager 202 initiates each of the example ghost group generator 206, the example starter product matcher 208, the example ghost group rule manager 210, the example utility estimator 212, the example scenario manager 214, the example probability calculator 216, and the example weight manager 218. The example respondent pool 102 is invoked by the example choice share manager 202 to perform one or more choice tasks that, in part, identifies human respondents from the human respondent pool 102 that may be used for a discrete choice exercise. Discrete choice exercises may include, but are not limited to, virtual shopping trips that present products and/or sets of products to the human respondents on a computer screen, video monitor, television, etc. Choice data is collected by the example choice share manager 202 and the example utility estimator 212 estimates utilities for each of the products of interest based on choice selection data acquired from the human respondents (e.g., during the virtual shopping trip(s)).

One or more of the products presented in the virtual shopping trip may include refill products that are associated with a corresponding holder product. In response to a human respondent's choice (e.g., simulated purchase) of the refill product, the example ghost group generator 206 identifies those participating human respondents from the choice exercise and generates one or more groups based on the product selected during the exercise and/or owned by the respondent. For example, the ghost group generator 206 may create a group associated with an existing razor starter product (e.g., a razor holder and corresponding refill product that is currently available in the marketplace) purchased by any number of the human respondents because such human respondents already own the corresponding holder and/or may have one or more similarities to each other (e.g., all are men, all shave their faces, all purchased razor refills having a similar price-point, etc.). Additionally, the example ghost group generator 206 creates a ghost group related to the new holder of interest that is not yet available in the market. As described in further detail below, the ghost group receives utility values derived from one or more alternate groups that are deemed similar to the new holder product.

The human respondents may be presented with one or more razor holder and/or refill products that do not yet exist in the marketplace, but were offered to the human respondent during the choice exercise as one of the products available for (virtual) purchase. While the new holder and/or refill product does not actually exist and/or is not yet available in the marketplace (e.g., due to feasibility testing, further market studies to determine marketplace viability, etc.), the example product matcher 208 operates to identify matches between that new product of interest and one or more products that are currently available in the marketplace that may be similar to the new product. For example, the product matcher 208 identifies a test starter product (an existing and available marketplace product) that matches a selected starter product (i.e., a holder and refill combination) that has one or more degrees of similarity to the new starter product, a new holder product, and/or a new refill product. Similarity between the products may be identified based on product features and/or purchasing dynamics. For example, the test starter product may be dissimilar to one or more physical attributes of the new product, but may have relatively substantial similarities relating to purchasing dynamics, such as, but not limited to, how the product is sold (e.g., in packages of two, etc.), when the product is sold (e.g., seasonal trends, etc.), and/or where the product is sold (e.g., specialty stores, geographic regions, etc.).

Any number of test product criteria may be employed to ascertain the degree of similarity and determine which existing starter product(s) may be deemed most similar to the new holder and/or refill product(s), including inputs from the sales forecaster, inputs from a product specialist, and/or inputs from a market analyst. Based on, in part, the existing starter product deemed most similar to the new holder and/or refill product(s), the example starter product matcher 208 copies the corresponding existing product utility value(s) to a ghost group that is representative of consumers that will behave in a similar manner.

In the illustrated example of FIG. 2, one or more ghost group adjustment rules are generated by the example ghost group rule manager 210 to reflect differences between the new holder and/or refill product(s) of interest and the existing holder/refill product(s) that were deemed similar during the virtual shopping trip(s). Differences may include, but are not limited to product feature differences, quantity differences, price differences, and/or target demographic differences. Additionally, the example ghost group rule manager 210 applies the adjustment rules to the copied utility values in an effort to tailor the ghost groups to behave in a manner similar to the groups from which the utility values were copied. Tailoring efforts may include, but are not limited to altering one or more utility values. The example adjustment rules may force the choice probability values of the ghost respondents via application of one or more weighting factors. For example, if existing refill product A (e.g., compatible with starter product A) has a choice probability value of 0.91, which is indicative of a respondent's probability for purchasing that refill, then the example adjustment rules may tailor one or more utility values associated with the new refill product while maintaining and/or otherwise preserving the same choice probability value of 0.91 for that new refill product in a new ghost group.

The example utility estimator 212 estimates utility values associated with the new product based on, in part, the utility adjustments applied as a result of the one or more adjustment rules. As described above, utility value estimations may be accomplished via one or more classification model(s), such as an example hierarchical Bayes estimation model. The hierarchical Bayes estimation is beneficial because it estimates at a level of resolution related to each respondent rather than a more generalized population level, but any other technique to estimate utilities may be employed. Respondent level estimation provides insight to heterogeneity of preferences among the population. Utility values from the new products (e.g., associated with the new product in a ghost group) and utility values from the existing market-available products purchased by the human respondents may further be combined by the example choice share manager 202 to create a model on which one or more simulations may be executed to calculate choice shares.

One or more scenarios, simulations, and/or scenario parameters are defined by the example scenario manager 214. The scenario manager 214 employs simulated customers (e.g., consumers) during one or more scenario and/or simulation iterations. Simulated customers used during such scenarios and/or simulations include the ghost respondents, but may also include the human respondents. Specific products are made available to one or more simulated consumers, specific prices for each of the available products, and/or specific promotions available to the simulated consumers (e.g., percentage discounts from an original price, buy-one-get-one-free discounts, etc.). Additionally, the example scenario manager 214 defines any number of simulated purchase iterations that, in part, allow the sales forecaster to identify how possession of the new holder and/or refill product(s) affects subsequent purchasing behavior of the simulated customers. Scenario parameters and utility values are used by the example probability calculator 216 to calculate probability values for each ghost simulated consumer view of each product (e.g., the existing starter product(s) and/or the new holder and/or refill product(s)). For each iteration defined by the example scenario manager 214, the example weight manager 218 performs an iterative weight adjustment for the simulated consumers in which the weight values and probabilities from the simulated consumers facilitate choice share calculations to be used by the sales forecaster. As described in further detail below, the example choice share manager 202 may employ a multinomial logit model to calculate choice shares.

While the example system to model with ghost groups 100 has been illustrated in FIG. 1, one or more of the interfaces, data structures, elements, processes, GUIs, and/or devices illustrated in FIGS. 1 and 2 may be combined, divided, re-arranged, omitted, eliminated and/or implemented in any other way. Further, the example respondent pool 102, the example discrete choice engine 104, the example starter product manager 106, the example choice share manager 202, the example ghost group generator 206, the example starter product matcher 208, the example ghost group rule manager 210, the example utility estimator 212, the example scenario manager 214, the example probability calculator 216, and/or the example weight manager 218 of FIGS. 1 and 2 may be implemented by hardware, software, firmware and/or any combination of hardware, software and/or firmware. Thus, for example, any of the example respondent pool 102, the example discrete choice engine 104, the example starter product manager 106, the example choice share manager 202, the example ghost group generator 206, the example starter product matcher 208, the example ghost group rule manager 210, the example utility estimator 212, the example scenario manager 214, the example probability calculator 216, and/or the example weight manager 218 may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example respondent pool 102, the example discrete choice engine 104, the example starter product manager 106, the example choice share manager 202, the example ghost group generator 206, the example starter product matcher 208, the example ghost group rule manager 210, the example utility estimator 212, the example scenario manager 214, the example probability calculator 216, and/or the example weight manager 218 are hereby expressly defined to include a tangible medium such as a memory, a digital versatile disc (DVD), a compact disc (CD), etc. storing the firmware and/or software. Further still, a communication system may include interfaces, data structures, elements, processes and/or devices instead of, or in addition to, those illustrated in FIGS. 1 and 2 and/or may include more than one of any or all of the illustrated interfaces, data structures, elements, processes and/or devices.

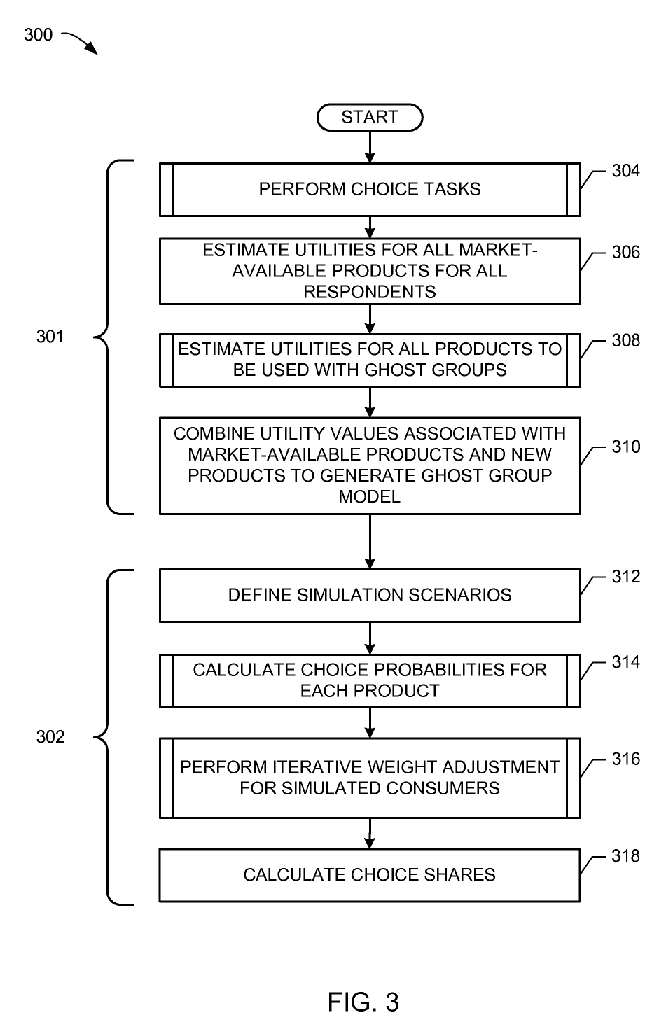

FIGS. 3-6, 8 and 9 illustrate example processes that may be performed to implement the example system 100 to model with ghost groups and/or the example starter product manager 106 of FIGS. 1 and 2. The example processes of FIGS. 3-6, 8 and 9 may be carried out by a processor, a controller and/or any other suitable processing device. For example, the example processes of FIGS. 3-6, 8 and 9 may be embodied in coded instructions stored on any tangible computer-readable medium such as a flash memory, a CD, a DVD, a floppy disk, a read-only memory (ROM), a random-access memory (RAM), a programmable ROM (PROM), an electronically-programmable ROM (EPROM), and/or an electronically-erasable PROM (EEPROM), an optical storage disk, an optical storage device, magnetic storage disk, a magnetic storage device, and/or any other tangible medium. Alternatively, some or all of the example processes of FIGS. 3-6, 8 and 9 may be implemented using any combination(s) of ASIC(s), PLD(s), FPLD(s), discrete logic, hardware, firmware, etc. Also, one or more of the example processes of FIGS. 3-6, 8 and 9 may instead be implemented manually or as any combination of any of the foregoing techniques, for example, any combination of firmware, software, discrete logic and/or hardware. Further, many other methods of implementing the example operations of FIGS. 3-6, 8 and 9 may be employed. For example, the order of execution of the blocks may be changed, and/or one or more of the blocks described may be changed, eliminated, sub-divided, or combined. Additionally, any or all of the example processes of FIGS. 3-6, 8 and 9 may be carried out sequentially and/or carried out in parallel by, for example, separate processing threads, processors, devices, discrete logic, circuits, etc.

The example process 300 of FIG. 3 generally includes generating a ghost group model 301 (blocks 304, 306, 308, 310) and performing a ghost group simulation 302 (block 312, 314, 316, 318). The example process 300 of FIG. 3 begins with the example choice share manager 202 invoking the example human respondent pool 102 to select and/or identify one or more human respondents from which to obtain choice data (block 304). Utilities for all market-available products for all respondents are estimated (block 306) and utilities for all products associated with the ghost groups are estimated (block 308) before combining (e.g., a database join operation) all of the utilities to form a ghost group model (block 310). One or more scenarios and/or simulations are defined by the example scenario manager 214 (block 312), which may include input(s) from the sales forecaster, an analyst, a market researcher, etc. Choice probabilities for each of the products possessed by the respondents are calculated by the example probability calculator 216 (block 314). Additionally, the example weight manager 218 performs an iterative weight adjustment for simulated consumers (block 316). The utilities and weights available to the example choice share manager 202 allow choice shares to be calculated (block 318), such as by way of a multinomial logit model.

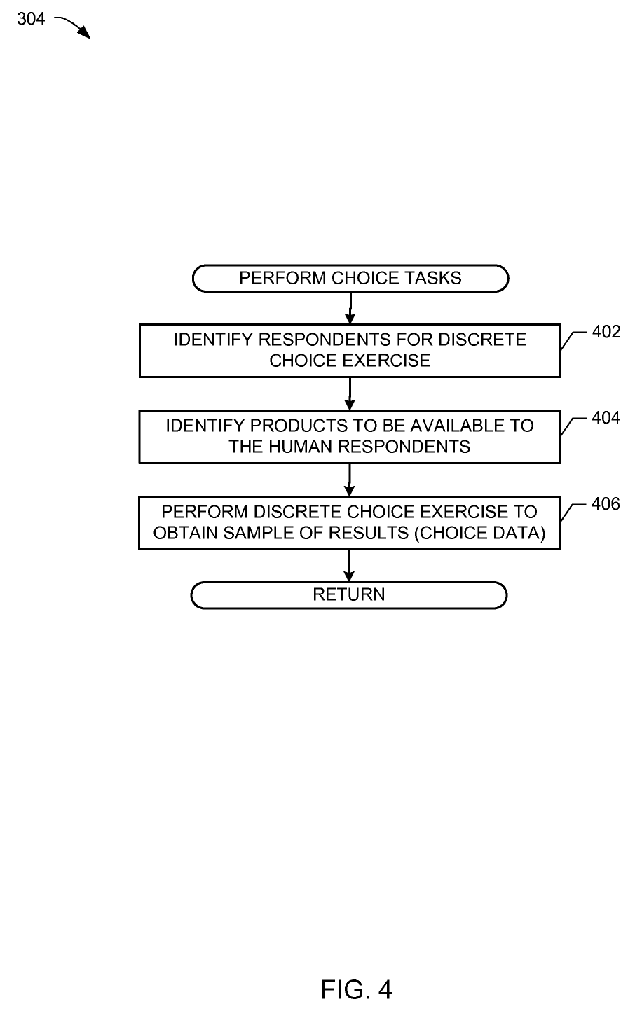

In the illustrated example of FIG. 4, performing choice tasks (block 304) is shown to include the example choice share manager 202 identifying human respondents for a discrete choice exercise (block 402). Human respondents may be selected based on, for example, one or more demographic characteristics in a manner to obtain statistical relevance in returned data. Achieving a statistically significant number of human respondents allows one or more results to be projected to a larger universe of similar consumers, households, etc., and/or to serve as a basis for one or more models. For each human respondent that is to participate in one or more virtual shopping trips (e.g., a discrete choice exercise), the example choice share manager 202 identifies products to be available to the human respondents (block 404). Human respondents are presented with products and/or product sets in a discrete choice exercise to obtain one or more samples of results (block 406). Sample results include, in part, selected product attributes, prices and/or any other variables considered for inclusion in the choice model. Briefly returning to FIG. 3, the choice results are used by the example utility estimator 212 to estimate utilities for the products (block 306), such as by employing a hierarchical Bayes estimation technique.

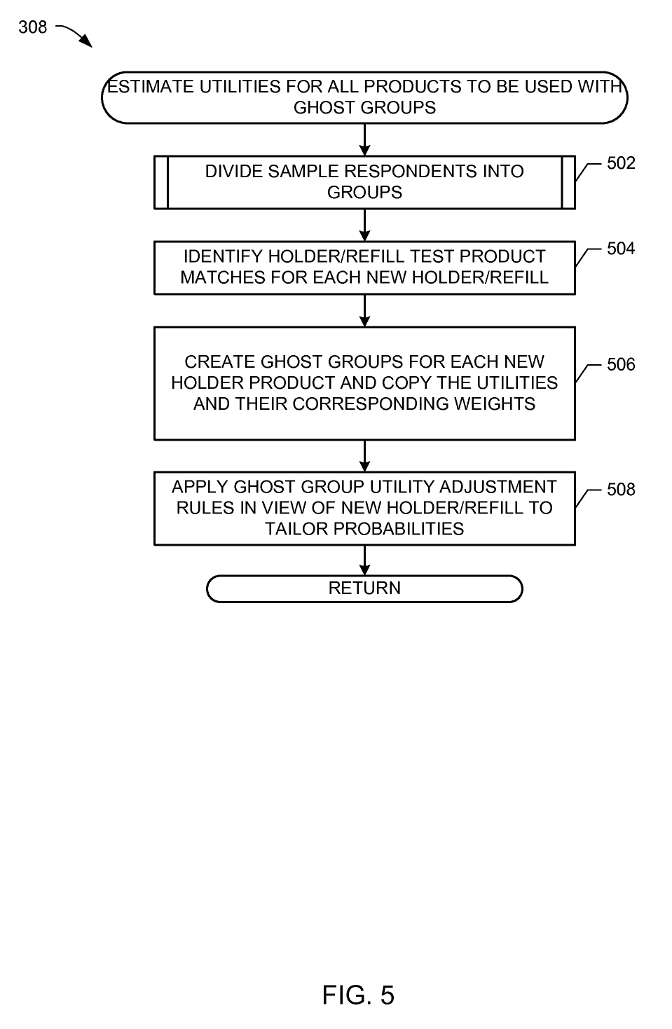

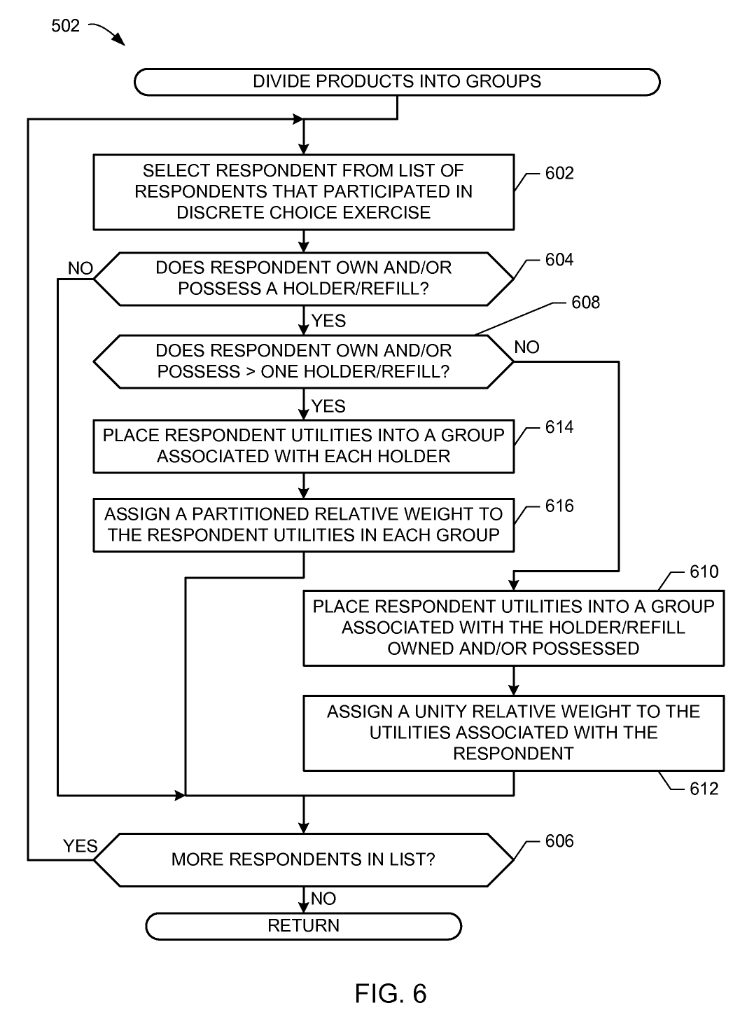

The example flowchart of FIG. 5 illustrates an example implementation of block 308 of FIG. 3. In the example of FIG. 5, each of the human respondents purchases different products during the discrete choice exercise, after which such products identified as owned and/or possessed by the human respondents are divided into groups (block 502). Availability and/or ownership of one or more products may occur from a virtual purchase during the discrete choice exercise and/or may occur by way of prior ownership of the product(s) prior to the human respondent(s) participating in the choice exercise. An example manner of implementing block 502 is shown in FIG. 6.

Turning to FIG. 6, one human respondent is selected from a list of human respondents that participated in the discrete choice exercise (block 602). In the event that the selected human respondent does not own and/or possess one of the holders (e.g., some or all of the starter product) available during the discrete choice exercise (block 604), control advances to block 606 to determine whether there are additional human respondents to evaluate. However, in the event that the selected human respondent does own/possess one of the holders and/or refills available during the discrete choice exercise (block 604), then the example ghost group generator 206 determines whether the selected human respondent owns and/or possesses (ownership status) more than one of the holders available during the choice exercise (block 608). If not, then the example ghost group generator 206 places the utilities associated with that selected human respondent into a group associated with only the holder that they own and/or possess (block 610) and assigns those associated utilities a unity relative weight value (block 612). However, if the selected human respondent owns and/or possesses more than one of the holders available during the choice exercise (block 608), then the example ghost respondent group generator 206 places the utilities associated with the selected human respondent into a group associated with each one of the products that they own and/or possess (block 614) and assigns a partitioned relative weight to those utilities in each of the associated groups (block 616). For example, if the human respondent owned and/or possessed both holder A and holder B, then that human respondent would be associated with a group related to holder A as well as a group related to holder B, but each instance the corresponding utilities would also be associated with a weight that is 50% of the unity value assigned to the utilities associated with a human respondent that only owned and/or possessed a single holder. The illustrated example of FIG. 6 repeats (block 606) if more human respondents are in the list, otherwise control returns to FIG. 5.

Returning to the illustrated example of FIG. 5, the starter product refill matcher 208 identifies an existing market-available holder/refill (e.g., the test product) that most closely matches one or more new holder/refill products (block 504) that were selected during the choice exercise. In some example instances, an agent performs one or more matching operations based on market expertise and/or market product familiarity. In other example instances, a suitable test product may be selected in response to one or more lookup table queries that specify, for example, a similar product category (e.g., 0-3 month baby foods, 3-6 month baby foods, baby formula, etc.), a similar product price point (e.g., high-end products, discount/value products, etc.), a similar/same brand name, a similar product purchasing dynamic, and/or a similar quantity (e.g., 6-pack, 12-pack, etc.). For each new holder product available during the discrete choice exercise (as decided by, for example, sales forecaster settings for available products and corresponding prices), the example ghost group generator 206 generates a corresponding ghost group and copies those corresponding product utilities to be used with the ghost group (block 506). When a new ghost group is created during the copy, all associated product utilities are also copied because, in part, those corresponding utilities are deemed to be the most similar to the type of human respondents that purchased the new holder in the discrete choice exercise. While the new ghost groups are deemed to be similar to a product that is similar to the new holder product, exact parity between the new product utilities and the market-available product utilities is not necessarily true. To accommodate for one or more differences between the existing starter products and the new holder and/or refill products, the example ghost group rule manager 210 applies and/or otherwise generates one or more adjustment rules to reflect one or more unique attributes of the new holder and/or refill products and/or to force the ghost group utilities to reflect a degree of consistency with choice probabilities of the test (similar) product (block 508). The adjustment rules may be generated based on, for example, one or more threshold parameters, mathematical weighting algorithms, and/or subjective weighting inputs from the sales forecaster.

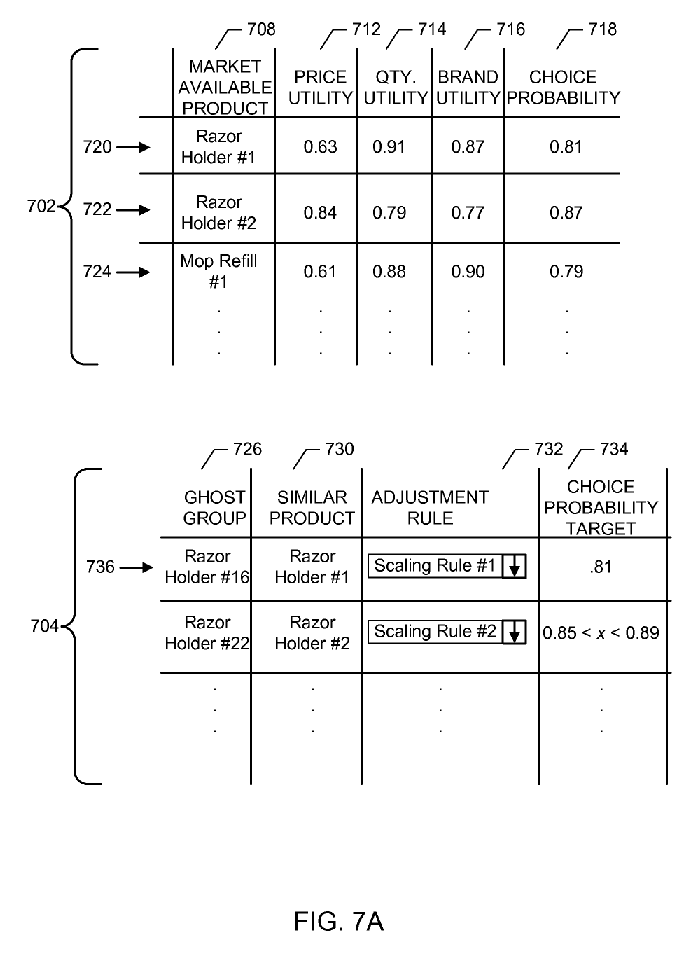

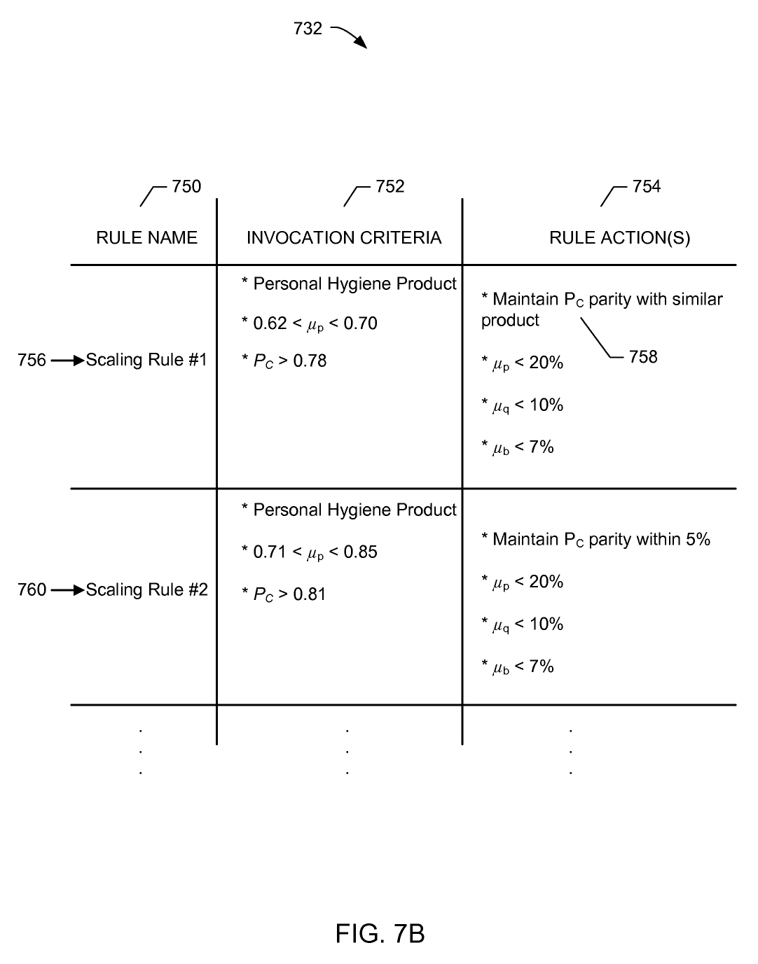

In the illustrated example of FIG. 7A, the example ghost group rule manager 210 generates a rule matrix 700 that includes currently available market products 702 and ghost groups 704, each of which were created because respondents own and/or possess the corresponding holder product(s). The currently available market products 702 further include a market-available product column 708, a price utility value column 712, a quantity utility value column 714, a brand utility value column 716, and a choice probability value column 718. The example utilities (712, 714, 716) illustrated in FIG. 7A are not to be construed as limiting, and any other number and/or type of utility value may be used by the example ghost group rule manager 210 to characterize products and/or characterize products in view of human respondent characteristics. As described above, the example ghost group generator 206 identifies one or more products purchased by the human respondents and generates product groups when the same or similar products are purchased during the virtual shopping exercise. Example row 720 reflects a group of purchasers of razor holder #1, which is a market-available refill product in the marketplace.

The example utility estimator 212, as described above, estimates utilities for products, such as holder products, refill products and/or starter products. Such utility values may be the result of human respondent preferences identified during one or more choice exercises, product attributes, and/or any combination thereof that are computed in accordance with, for instance, a hierarchical Bayes estimation. A choice probability associated with each human respondent and product may be derived as a function of the estimated utilities.

P_{C}=f(uₚ, u_{q}, u_{b}) Equation 1

In the illustrated example Equation 1, P_{C} is the choice probability 718 and is derived as a function of the price utility value μₚ 712, the quantity utility value μ_{q} 714 and the brand utility value μ_{b} 716. The example probability calculator 216 employs example Equation 1, or any other equation to calculate the choice probability 718. The example razor holder #1 (row 720) has a choice probability P_{C} of 0.81, as derived from example Equation 1. The example rule matrix 700 also includes other market-available products that are owned and/or possessed by the respondents, such as razor holder #2 (row 722), and mop refill #1 (row 724). Each of the corresponding product groups (e.g., shown in example rows 720, 722 and 724) illustrate respective utility values associated with the purchased market-available product as estimated by, for example, the hierarchical Bayes estimation.

The ghost groups 704 include a ghost group column 726, which represents future products, a similar product column 730, an adjustment rule column 732 having a user-selectable drop-down box for each row, and a choice probability column 734. As described above, the example starter product matcher 208 identifies a market-available test product (similar product) that most closely matches a holder and/or refill product of interest that is not yet available in the marketplace, but was available to the human respondents during the discrete choice exercise. In the illustrated example of FIG. 7A, razor holder #16 (row 736) was owned and/or otherwise possessed by respondents. While razor holder #16 is a product of interest not yet available in the marketplace, it was made available to the human respondents during the discrete choice exercise (e.g., the virtual shopping trip). The ghost group generator 206 generates, in this example, a new ghost group (row 736) to represent utilities associated with the new product in an effort to model respondent behavior associated with that new product. The example starter product matcher 208 identifies that, in this example, future product razor holder #16 is most similar to razor refill #1, as shown in the similar product column 730. As a result, the example ghost group generator 206 copies all of the utility values associated with razor holder #1 to the group of ghost respondents that purchased, possessed, and/or otherwise own razor holder #16 (row 736).

To address one or more differences between the future product in each group 728 and the similar product 730 identified by the example starter product matcher 208, the example ghost group rule manager 210 identifies and/or otherwise selects an adjustment rule 732 to be applied to the copied utilities. Generally speaking, copying one or more utility values from a similar existing market-available product to the future product allows for the establishment of a basis set of utility values on which to build and further tailor based on, for example, differences that may exist between the future product and the market-available product. The selected adjustment rule 732 adjusts one or more utility values derived from the corresponding similar product to reflect one or more attributes unique to the new product. Utility values available for adjustment by the one or more adjustment rules 732 include, but are not limited to the generalized utility value 710, the price utility value 712, the quantity utility value 714 and/or the brand utility value 716. In some example instances, the selected adjustment rule operates to tailor one or more utility values in a manner consistent with attributes of the new product while maintaining a similar or identical choice probability value.

In the illustrated example of FIG. 7B, example adjustment rules 732 available for selection by the example ghost group rule manager 210 are shown having a rule name column 750, an invocation criteria column 752, and a rule action column 754. In operation, the example ghost group rule manager 210 parses data in the currently available market product groups 702 and the ghost groups 704 for matching invocation criteria 752. Upon finding a match of criteria, the example ghost group rule manager 210 executes one or more actions identified in the corresponding rule action column 754 in an effort to tailor the one or more utilities associated with the ghost group and new product. The one or more adjustment rules 732 may be stored in a memory, automatically selected by the example ghost group rule manager 210 based on the one or more criteria, and/or such adjustment rules 732 may be manually selected by the sales forecaster.

In the illustrated example of FIG. 7B, scaling rule #1 (row 756) is invoked by the ghost group rule manager 210 when the market-available product and future product are related to personal hygiene, the price utility value 712 is between a threshold value of 0.62 and 0.70, and the choice probability 718 is greater than 0.78. In view of those example invocation criteria, the example ghost group rule manager 210 identifies that scaling rule #1 is applicable to the utility values (i.e., 712, 714, 716) associated with razor holder #1 (row 720). Additionally, scaling rule #1 indicates, via the rule action column 754, that the resulting choice probability is to be maintained at parity with the choice probability of the similar product 758. In other words, regardless of how the one or more utility values (712, 714, 716) are adjusted, the resulting choice probability for the new product should be the same as that associated with the similar product. Example scaling rule #1 also specifies, via the rule actions column 754, that μₚ (i.e., price utility value) deviation must be less than 20%, μ_{q} (i.e., quantity utility value) deviation must be less than 10%, and μ_{b} (i.e., brand utility value) deviation must be less than 7%.

Example scaling rule #2 (row 760) is invoked by the example ghost group rule manager 210 when the market-available product and future product are related to personal hygiene, the price utility value 712 is between 0.71 and 0.85, and the choice probability 718 is greater than 0.81. In view of those example invocation criteria, the example ghost group rule manager 210 identifies that scaling rule #2 is applicable to the utility values (i.e., 712, 714, 716) associated with razor holder #2 (row 722). Additionally, scaling rule #2 indicates, via the rule action column 754, that the resulting choice probability may be maintained within a tolerance value 762.

Returning to FIG. 3, the utility values associated with the market-available products and the new products are combined to generate a ghost model (block 310). Using the ghost model, one or more simulations may be created and executed to, in part, calculate resulting choice shares indicative of consumer behavior with respect to new refill products that are not yet in the marketplace. The sales forecaster and/or any other user may define one or more scenario parameters that constrain and/or otherwise manipulate how the ghost model operates (block 312). Scenario parameters defined by the example scenario manager 214 (block 314) may identify, for example, specific products (e.g., existing holders, existing refills, new holders, new refills, etc.), specific prices for the products, and/or specific promotional parameters associated with the products (e.g., introductory price reductions, one or more price reduction durations, seasonal price fluctuations, etc.). Such parameters may also define a number of scenario iterations to observe, in part, the behavioral effects of consumers when they do not own/possess one or more holders versus when they do own/possess one or more holders.

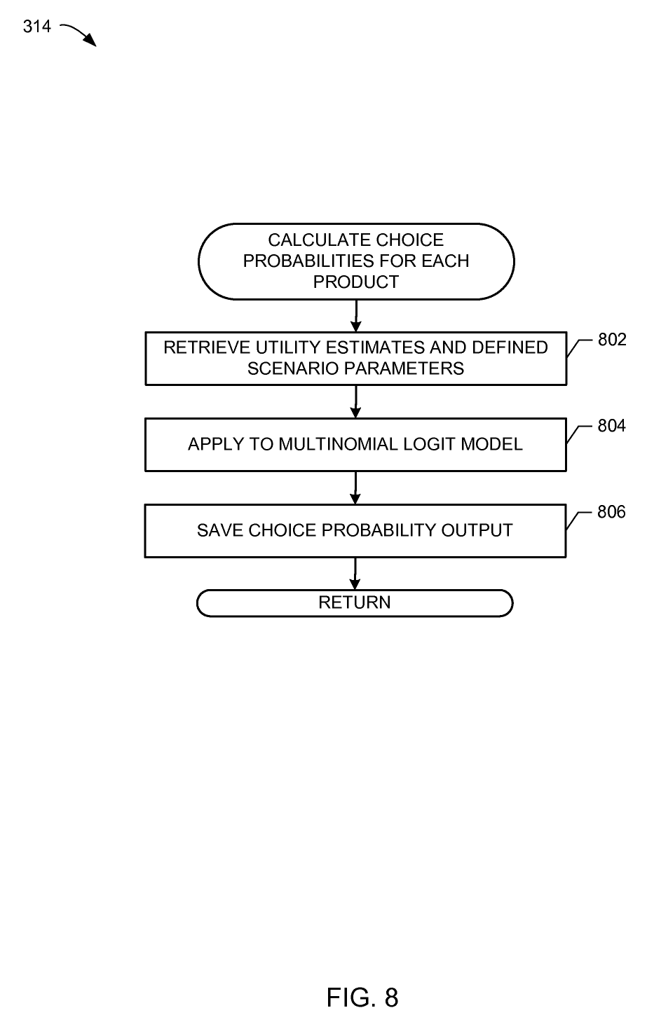

Respondent choice probabilities, which are derived from utility values, are calculated by the example probability calculator 216 (block 314). In the illustrated example of FIG. 8, the example probability calculator 216 retrieves and/or otherwise receives the utility estimates and the defined scenario parameters (block 802). The example probability calculator 216 may calculate the one or more choice probabilities in any manner including application of a multinomial logit model (block 804). As described above, utility values are based on product attributes, utility values, price, promotion(s), price reduction tags, features, etc.

$${P}_{A} = \frac{{e}^{{μ}_{A}}}{{e}^{{μ}_{A}} + {e}^{{μ}_{B}} + {e}^{{μ}_{C}} + … + {e}^{{μ}_{n}}} \qquad Equation 2$$

In the illustrated example Equation 2 P_{A} is the choice probability for product A (e.g., a holder, a refill, etc.), and μ is the product utility (e.g., μ_{A} is the utility for product A, μ_{B} is the utility for product B, etc.). In the event that multiple products (e.g., A, B, C, etc.) are included during the ghost respondent simulation 302, the sum of all probability values (e.g., P_{A}, P_{B} and P_{C}) will add up to a value of 1.0. Additionally, the product utility may be represented as shown below in Equation 3.

μᵢ=βᵢ+β_{price}+βₚᵣₒₘₒ Equation 3

In the illustrated example Equation 3, βᵢ may represent a general utility for product i (e.g., where i represents product A, product B, etc.), β_{price} may represent a utility value related to the price of the product, and βₚᵣₒₘₒ may represent a utility value related to a promotion associated with the product. Each iterative evaluation of a scenario that is applied to the example ghost respondent model may include one or more different values for the utility values associated with each product of interest. Probability values calculated, such as by way of the example multinomial logit model, are saved for later use during the simulation 302 (block 806).

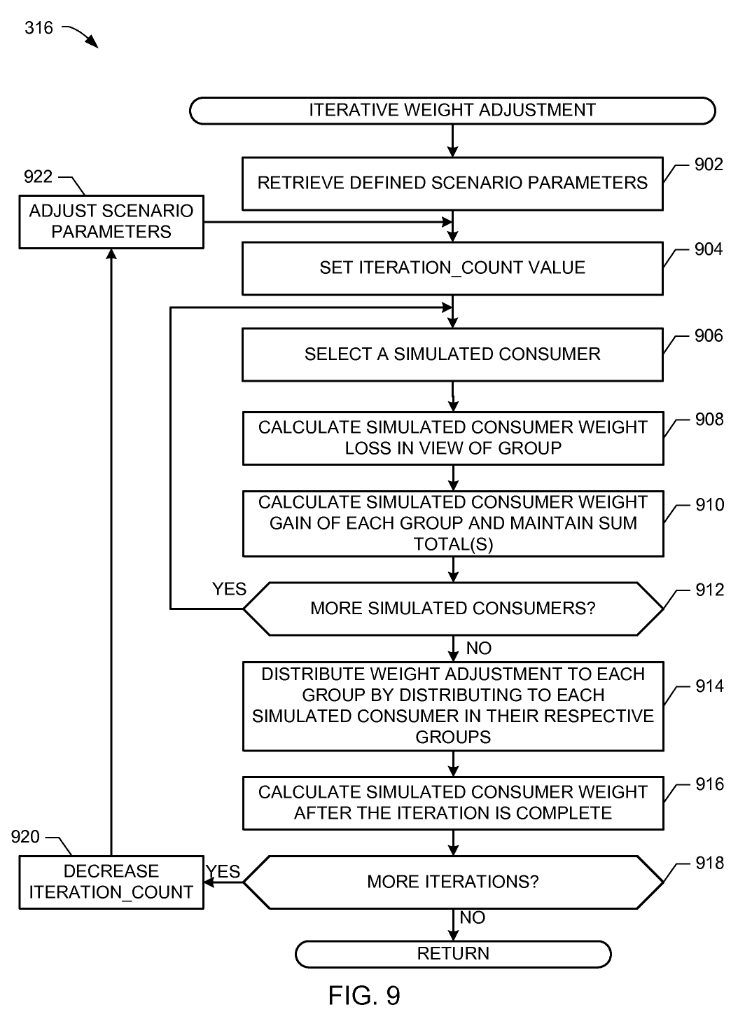

Returning to FIG. 3, the example weight manager 218 performs an iterative weight adjustment for simulated consumers to, in part, calculate weight values before and after each iteration (block 316), which is described further below in the illustrated example of FIG. 9. Generally speaking, because some groups are associated with existing holder products and some groups (e.g., the ghost groups) are associated with future holder products, the iterative scenario iteration(s) illustrate how holder groups may change over time based on, in part, category purchasing activity. Some respondents have starter product A, for example, and over time such respondents may also purchase other starter products and/or corresponding refills (e.g., products A, B, C, etc.). Such purchasing behavior illustrates a dynamic ebb and flow of product market activity and/or strength.

For example, a new starter product Z may grow during the simulation in response to additional respondents purchasing that starter product and corresponding refills for example starter product Z. However, such purchasers of starter product Z and/or refills for starter product Z may decrease and/or discontinue their purchase of starter product A and its associated refill(s). The methods and apparatus described herein perform one or more simulated scenario purchasing iterations to identify and/or otherwise calculate a distributed weight from the one or more product groups that are indicative of changes in respondent purchasing behavior of the one or more starter products and/or corresponding refill product(s). Generally speaking, because each iteration of the simulation may change one or more choice probability values (e.g., what a consumer purchases in the past may affect what that consumer will purchase in the future), weight values associated with the simulated consumers are adjusted accordingly. For example, if in a first iteration there is a 10% chance (probability) that product A will be purchased and a 5% chance that product D will be purchased, weight values for simulated consumers associated with product A will be calculated based on the product between the probability and a transitional proportion factor (α). As described in further detail below, the transitional proportion factor (α) facilitates weight calculations in view of likely behaviors of one or more respondents. However, any weights added to one or more simulated consumers in a product group are balanced by decreasing the remaining product group weights in a distributive manner. For example, simulated consumer weight values for products B and C will decrease by 7.5% each to balance-out the weight gains in product groups A and D.

In some instances, a respondent may make a purchase of new holder product Z in one or more subsequent scenario purchasing iterations when that respondent already owns holder product A. To distribute a proportion of the weight gained or lost by either group, the example weight manager 218 may employ a transitional proportion factor (α). The transitional proportion factor (α) represents how more likely a respondent that owns two holders is to behave like an owner of the more recently purchased holder than an owner of the less recently purchased holder. In operation, a value of α=1.00 represents holders that completely discontinue using (e.g., throw-away) the older holder, while a value of α=0.50 represents a situation in which the respondent will demonstrate an equal likelihood to behave like an owner of either holder.

In the illustrated example of FIG. 9, the weight manager 218 retrieves and/or otherwise receives the defined scenario parameters (block 902) and sets an iteration count value (block 904) (e.g., 10-iterations). One simulated consumer is selected (block 906) and a corresponding weight loss, if any, is calculated based on the group with which the simulated consumer is associated (block 908). Assuming, for purposes of example, four groups of corresponding products are used in the simulation (e.g., holder products A, B, C and D and refill products A₁, B₁, C₁ and D₁), weight loss values may be calculated by example Equations 4-7, as shown below.

W_{R-A}=0 Equation 4

W_{R-B}=W_{Rb}×P_{RB} Equation 5

W_{R-C}=W_{Rb}×P_{RC} Equation 6

W_{R-D}=W_{Rb}×P_{RD} Equation 7

In the illustrated example Equations 4-7, W_{Rb} represents the weight of simulated consumers (e.g., simulated respondents) R before the current iteration, W_{R-A} represents the weight of simulated consumers R lost in group A, W_{R-B} represents the weight of simulated consumers R lost in group B, W_{R-C} represents the weight of simulated consumers R lost in group C, and W_{R-D} represents the weight of simulated consumers R lost in group D. Additionally, P_{RA}, P_{RB}, P_{RC} and P_{RD} represent the respective probabilities for purchasing each of the products A, B, C and D. Note that W_{R-A} is zero because of the assumption, in this example, that simulated consumer R already owns holder product A.

While some product groups may experience a weight loss during one or more iterations, other product groups may experience a weight gain (block 910), which may be calculated by example Equations 8-11, as shown below. Additionally, one or more iterations of example blocks 906 through 910 facilitate maintenance of a sum total(s) of weight gain(s) and/or loss(es) via example Equations 8-11.

$$\begin{matrix}{W}_{+ A} = {\sum }_{r ∈ population} {W}_{r - A} & Equation 8 \\ {W}_{+ B} = {\sum }_{r ∈ population} {W}_{r - B} & Equation 9 \\ {W}_{+ C} = {\sum }_{r ∈ population} {W}_{r - C} & Equation 10 \\ {W}_{+ D} = {\sum }_{r ∈ population} {W}_{r - D} & Equation 11\end{matrix}$$

In the illustrated example Equations 8-11, W_{+A}, W_{+B}, W_{+C} and W_{+D} represent the weights gained by each of product groups A through D, and W_{r-A}, W_{r-B}, W_{r-C} and W_{r-D} represent weight values of individual simulated consumers (little “r”) within each of those product groups A through D. The individual simulated consumer weight values may then be added back to the total number of simulated consumers (big “R”), as shown by example Equation 12.

$${W}_{R +} = \frac{{W}_{Rb}}{{\sum }_{r ∈ group ( A )} {W}_{rb}} \times {W}_{+ A} \qquad Equation 12$$

In the illustrated example Equation 12, W_{R+} represents the weight of all simulated consumers R gained in the distribution of added weights to (in this example) group A, of which r is a member. In the event that there are additional simulated consumers to evaluate within the groups (block 912), control returns to block 906 to select another simulated consumer. Otherwise, weight adjustments for each group and each individual simulated consumer in the groups are applied among the groups that participated in the simulation (block 914). The weight of respondent R after the entire iteration is complete (block 916) may be calculated by example Equation 13, as shown below.

W_{Ra}=W_{Rb}−W_{R-A}−W_{R-B}−W_{R-C}−W_{W-D}+W_{R+} Equation 13

In the illustrated example Equation 13, W_{Ra} represents the weight of the individual r after the current iteration has completed. The example weight manager 218 determines whether the defined scenario parameters include one or more additional iterations to apply during the simulation (block 918). If so, the iteration count is decreased by one (block 920) and the scenario parameters associated with the next iteration are adjusted (block 922). As described above, any number and type of scenario parameters may be adjusted including, but not limited to available products in the simulation, product prices and/or one or more promotions associated with each of the available products. Returning to FIG. 3, the estimated utilities, ghost utilities, and adjusted weights are used to calculate choice share values as output for the sales forecaster (block 318).

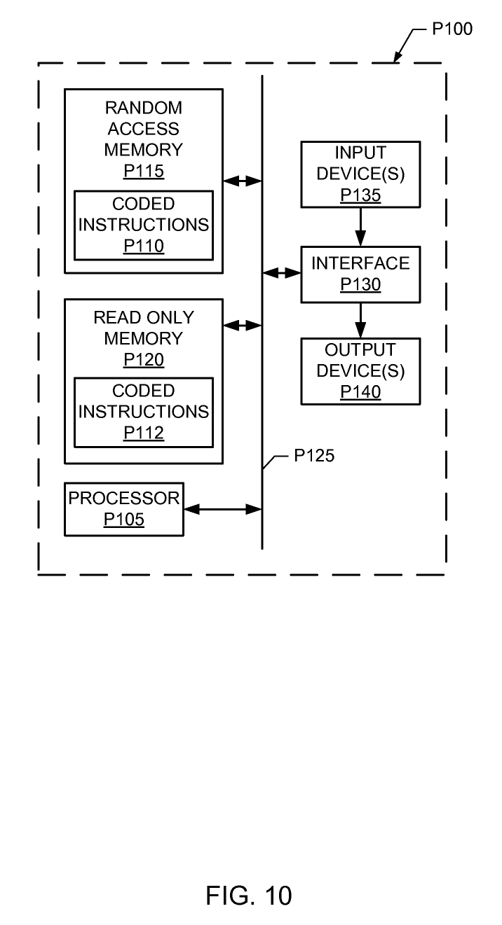

FIG. 10 is a schematic diagram of an example processor platform P100 that may be used and/or programmed to implement any or all of the example respondent pool 102, the example discrete choice engine 104, the example ghost respondent manager 106, the example choice share manager 202, the example ghost respondent generator 204, the example ghost respondent group generator 206, the example holder/refill product matcher 208, the example ghost group rule manager 210, the example utility estimator 212, the example scenario manager 214, the example probability calculator 216, and/or the example weight manager 218 of FIGS. 1 and 2. For example, the processor platform P100 can be implemented by one or more general-purpose processors, processor cores, microcontrollers, etc.

The processor platform P100 of the example of FIG. 10 includes at least one general-purpose programmable processor P105. The processor P105 executes coded instructions P110 and/or P112 present in main memory of the processor P105 (for example, within a RAM P115 and/or a ROM P120). The processor P105 may be any type of processing unit, such as a processor core, a processor and/or a microcontroller. The processor P105 may execute, among other things, the example processes of FIGS. 3-6, 8 and 9 to implement the example methods and apparatus described herein.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. Access to the memory P115 and the memory P120 may be controlled by a memory controller (not shown).

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A computer implemented method to model a new product, comprising:
estimating discrete choice utility values for a plurality of respondents based on a plurality of market-available products;
dividing the plurality of respondents into groups based on an ownership status of the plurality of market-available products;
identifying a test starter product from the plurality of market-available products based on test criteria indicative of a degree of similarity with the new product;
generating a ghost group associated with the new product;
assigning utility values of the test starter product to the new product in the ghost group;
tailoring the utility values assigned to the new product with a ghost group utility adjustment rule; and
generating a ghost group model to represent consumers of the new product.

2. A method as defined in claim 1, wherein estimating the discrete choice utility values further comprise performing a hierarchical Bayes estimation on discrete choice responses received from a discrete choice exercise virtual shopping trip.

3. A method as defined in claim 1, wherein the market-available product comprises a holder product and a corresponding refill product.

4. A method as defined in claim 1, wherein the test criteria comprise at least one of a product category threshold, a product size threshold, a product price point threshold, or a product promotion threshold.

5. A method as defined in claim 1, further comprising assigning a first one of the plurality of respondents a unity weight when the first one of the plurality of respondents owns a single one of the plurality of market-available products.

6. A method as defined in claim 1, further comprising assigning a relative partitioned weight to a first one of the plurality of respondents when the first one of the plurality of respondents owns more than one of the plurality of market-available products.

7. A method as defined in claim 1, wherein tailoring the new product utility values further comprises altering a sub-utility value within a threshold value to preserve a choice probability value.

8. A method as defined in claim 1, wherein the ghost group utility adjustment rule is selected based on invocation criteria comprising a threshold sub-utility value associated with the test starter product.

9. A method as defined in claim 1, further comprising combining the tailored product utility values with the discrete choice utility values to create the ghost group model.

10. A method as defined in claim 9, further comprising receiving a simulation scenario to apply to the ghost group model.

11. A method as defined in claim 10, wherein the simulation scenario comprises at least one of an available product, a price of the available product, or a promotion for the available product.

12. A method as defined in claim 10, further comprising calculating choice probability values for each of the plurality of respondents and for the ghost group associated with the new product based on the simulation scenario and the combined utility values in the ghost group model.

13. A method as defined in claim 12, wherein calculating the choice probability values comprises employing a multinomial logit model.

14. A method as defined in claim 12, further comprising performing a respondent group weight adjustment for a number of iterations identified by the simulation scenario.

15. A method as defined in claim 14, further comprising calculating at least one of a respondent weight decrease or a respondent weight increase based on the calculated choice probability values associated with each of the plurality of market-available products and the new product.

16. A method as defined in claim 15, further comprising distributing the weight decrease or weight increase to each of the plurality of respondents and the plurality of ghost respondents.

17. A method as defined in claim 15, further comprising calculating choice shares based on the calculated choice probability values, the combined utility values, and the at least one of the respondent weight decrease or weight increase.

18. A method as defined in claim 1, wherein modeling the new product further comprises employing a choice modeling exercise.

19. A method as defined in claim 1, wherein modeling the new product further comprises modeling a product category.

20. An apparatus to model new products, comprising:
a utility estimator to estimate discrete choice utility values for a plurality of market-available products;
a product matcher to identify a match between the new product and a test starter product from the plurality of market-available products, the product matcher identifying a degree of similarity between the new product and the test starter product;
a ghost group rule manager to generate tailored utility values for the new product based on the test starter product; and
a choice share manager to combine the tailored utility values with the discrete choice utility values to create a ghost group model.

21. An apparatus as defined in claim 20, wherein the utility estimator further comprises a hierarchical Bayes estimation model to calculate utility values from discrete choice responses received from a discrete choice exercise.

22. An apparatus as defined in claim 20, further comprising a ghost group generator to generate starter product groups based on a respondent ownership status of each of the plurality of market-available products.

23. An apparatus as defined in claim 22, further comprising a weight manager to assign one of a plurality of respondents a unity weight when one of the plurality of respondents owns a single one of the plurality of market-available products.

24. An apparatus as defined in claim 22, further comprising a weight manager to assign one of a plurality of respondents a relative partitioned weight when one of the plurality of respondents owns more than one of the plurality of market-available products.

25. An article of manufacture storing machine accessible instructions that, when executed, cause a machine to:
estimate discrete choice utility values for a plurality of respondents based on a plurality of market-available products;
divide the plurality of respondents into groups based on an ownership status of the plurality of market-available products;
identify a test starter product from the plurality of market-available products based on test criteria indicative of a degree of similarity with the new product;
generate a ghost group associated with the new product;
assign utility values of the test starter product to the new product in the ghost group;
tailor the utility values assigned to the new product with a ghost group utility adjustment rule; and
generate a ghost group model to represent consumers of the new product.

26. An article of manufacture as defined in claim 25, wherein the machine readable instructions, when executed, cause the machine to perform a hierarchical Bayes estimation on discrete choice responses received from a discrete choice exercise virtual shopping trip.

27. An article of manufacture as defined in claim 25, wherein the machine readable instructions, when executed, cause the machine to assign a first one of the plurality of respondents a unity weight when the first one of the plurality of respondents owns a single one of the plurality of market-available products.

28. An article of manufacture as defined in claim 25, wherein the machine readable instructions, when executed, cause the machine to assigning a relative partitioned weight to a first one of the plurality of respondents when the first one of the plurality of respondents owns more than one of the plurality of market-available products.

29. An article of manufacture as defined in claim 25, wherein the machine readable instructions, when executed, cause the machine to alter a sub-utility value within a threshold value to preserve a choice probability value.

30. An article of manufacture as defined in claim 25, wherein the machine readable instructions, when executed, cause the machine to select the ghost group utility adjustment rule based on invocation criteria comprising a threshold sub-utility value associated with the test starter product.

31. An article of manufacture as defined in claim 25, wherein the machine readable instructions, when executed, cause the machine to combine the tailored product utility values with the discrete choice utility values to create the ghost group model.

32. An article of manufacture as defined in claim 31, wherein the machine readable instructions, when executed, cause the machine to receive a simulation scenario to apply to the ghost group model.

33. An article of manufacture as defined in claim 32, wherein the machine readable instructions, when executed, cause the machine to calculate choice probability values for each of the plurality of respondents and for the ghost group associated with the new product based on the simulation scenario and the combined utility values in the ghost group model.

34. An article of manufacture as defined in claim 33, wherein the machine readable instructions, when executed, cause the machine to employ a multinomial logit model to calculate the choice probability values.

35. An article of manufacture as defined in claim 33, wherein the machine readable instructions, when executed, cause the machine to perform a respondent group weight adjustment for a number of iterations identified by the simulation scenario.

36. An article of manufacture as defined in claim 35, wherein the machine readable instructions, when executed, cause the machine to calculate at least one of a respondent weight decrease or a respondent weight increase based on the calculated choice probability values associated with each of the plurality of market-available products and the new product.

37. An article of manufacture as defined in claim 36, wherein the machine readable instructions, when executed, cause the machine to distribute the weight decrease or weight increase to each of the plurality of respondents and the plurality of ghost respondents.

38. An article of manufacture as defined in claim 36, wherein the machine readable instructions, when executed, cause the machine to calculate choice shares based on the calculated choice probability values, the combined utility values, and the at least one of the respondent weight decrease or weight increase.
